(19) United States
(12) Patent Application Publication
(10) Pub. No.: US 2022/0016804 A1
(43) Pub. Date: Jan. 20, 2022

(54) Method for Forming a Preform Charge and a Part Having a Complex Geometry

(71) Applicant: Arris Composites Inc., Berkeley, CA (US)

(72) Inventors: J. Scott PERKINS, Oakland, CA (US); Arnaud DYEN, San Francisco, CA (US); Nataniel JACOBSON, Alameda, CA (US); Gary Alan HOGUE, Berkeley, CA (US)

(21) Appl. No.: 17/376,950

(22) Filed: Jul. 15, 2021

Related U.S. Application Data
(60) Provisional application No. 63/052,255, filed on Jul. 15, 2020.

(51) Int. Cl. B29B 11/16; B29B 11/12; B29C 65/00; B29C 70/20; B29C 70/54

(52) U.S. Cl. CPC B29B 11/16; B29B 11/12; B29C 66/1122; B29C 70/543; B29C 66/73921; B29C 70/20; B29C 66/721

(57) ABSTRACT

A method for forming a preform charge having a complex geometry includes determining a partitioning axis defining first and second portions the preform charge, each portion having a major segment and a minor segment that are not co-planar with each other, creating a fixture having segregable elements that form cavities for partially consolidating the major segments of the first and second portions, and a cavity for partially consolidating the minor segments, separately partially consolidating the major segments, and, while partially consolidating the major segments to one another, forming the minor segments and partially consolidating them to the major segments. And a fixture capable of carrying out the method.

### STATEMENT OF RELATED CASES

This specification claims priority to U.S. Pat. App. Ser. No. 63/052,255, filed Jul. 15, 2020, which is incorporated by reference herein.

### FIELD OF THE INVENTION

The present invention relates to the manufacture of fiber-composite parts.

### BACKGROUND

Applicant has previously disclosed the use of fiber-bundle based preforms and preform charges to enhance process efficiency for the manufacture, via compression molding, of fiber-composite parts.

### SUMMARY

The present invention provides a way to create, via compression molding, parts having a complex geometry.

As the term is used in this specification, a “preform” is a bundle of resin-impregnated fibers, which is typically sourced from towpreg, or the output from an impregnation line. In addition to being cut to a desired size, the preform is usually shaped, so as to fit the contours of a mold in which it is to be placed, or to provide a desired fiber alignment at a discrete region of the mold. Applicant has taught that creating a lay-up of such fiber-bundle-based preforms in a mold provides an ability to tailor, with great specificity, the fiber alignment within a mold, and hence within a part formed therefrom. This enables the fabrication of parts having superior mechanical properties for particular use cases. But there are some drawbacks associated with placing preforms one-by-one in a mold to form a lay-up, not the least of which being the amount of time involved in doing so.

To address this problem, applicant developed the “preform charge,” which is an assemblage of such fiber-bundle based preforms. The preforms in a preform charge are joined together, via heating and compression, to effectively becoming a single structure. The preform charge, which is often created in a special fixture, conforms to the shape of the mold, or significant portions of it. In parts having a relatively simple geometry, the preform charge serves mainly to improve process efficiency by enabling a single “pick and place” transfer to the mold, as opposed to repeated transfers of individual preforms.

For parts having a relatively complex geometry, the use of a preform charge may be a necessity, rather than simply a convenience. More particularly, it may be exceedingly difficult if not impossible to create, in molds having some types of complex geometries, the requisite preform lay-up by simply adding preforms one-by-one to the mold.

Consider, for example, a part in which a first portion thereof falls in a first plane, and a second portion aligns with a second plane, wherein the two planes are out-of-plane with respect to one another (i.e., planes that are “out-of-plane” with respect to one another are defined as planes having normal vectors that are not parallel to one another). In applicant's processes, this will require certain preforms to be situated out-of-plane relative to other preforms. Depending on further specifics of the geometry, absent a pre-molding union between the preforms, such as provided by a preform charge, preforms might fall out of the desired alignment due to gravity. Although parts having such complex geometries could be created by placing chopped fiber in a simple mold, such parts would not exhibit the enhanced performance characteristics obtainable when using aligned fibers, as taught by applicant.

A further complication for such a part, and a preform charge used to mold it, is that fabrication of at least the preform charge may require the use of multiple compression axes. As a simple example, consider a preform charge having a first portion of its structure aligned with a first plane, and a second portion aligned with a plane that is 90 degrees off-axis to the first plane. To create the preform charge, pressure would need to be applied in two orthogonal directions to provide the requisite compression of the layup of preforms.

When faced with molding such a complex part using the fiber-bundle-based preforms, the challenge then becomes how to create the preform charge. One could potentially fabricate the part by producing plural preform charges, each corresponding to a different portion of the part. The preform charges would then be placed in a mold, and then subjected to elevated temperature and pressure (i.e., compression molding) to form the part. That might address both the issue of gravity and serve as a work around for the need for multiple compression axes to create the preform charge. However, for many parts having complex geometries, it is desirable to have fibers extend from one portion of the part to another for best mechanical properties. This is particularly true for parts having portions that are out-of-plane to one another. But if the part is formed by fabricating plural preform charges as described above, there will be no continuity of fiber between the various portions.

Embodiments of the invention address all of these issues: gravity, the requirement for multiple compression axes, and continuity of fiber between portions of a preform charge that are out-of-plane with respect to one another.

Some embodiments of the invention provide a method for fabricating a preform charge. In accordance with an illustrative embodiment of the method, the preform charge is fabricated in several portions, but such fabrication is performed (i) sequentially and (ii) using a part-specific preform-charge fixture. The use of the fixture in conjunction with the method enables continuity of fiber between the several portions, while addressing the challenges presented by gravity and the requirement for multiple compression axes when processing complex preform arrangements into a preform charge.

In some embodiments, a method for forming a preform charge for fabricating a part includes:
Determining at least one partitioning axis for the part being fabricated, the partitioning axis defining at least two portions of the part, each portion having a major segment aligned with a first plane (which typically aligns with the partitioning axis), and a minor segment aligned with a second plane, wherein the two planes do not fall in the same plane;
Creating a fixture having segregable elements in which preforms can be situated to form separate layups for the major segment of each portion of the part, and a single layup for the minor segment(s) of the part.
Separately forming a layup for the major segment of each portion of the part and separately partially consolidating such layups via heat and pressure.
Joining together the segregable elements of the fixture that are used to form the major segments of each portion of the part, wherein the two partially consolidated major segments reside in a cavity formed between the joined segregable elements.
Forming a single layup for minor segments of the part in a cavity created by the joined elements of the fixture, wherein the cavity has the appropriate out-of-plane orientation with respect to the partially consolidated major segments of the part.
Partially consolidating the minor segments of the part to the major segments of the part via heat and pressure.

Since the charge-forming fixture has segregable elements, the various segments of the preform charge are laid-up separately as permitted by gravity, and then partially consolidated. It is notable that to achieve the desired continuity of fiber between the major segments and the minor segments, preforms (fibers) extend from layups used to form the major segments to the region (i.e., cavity) where the minor segments are formed. To form the minor segments, the appropriate cavity receives additional preforms (i.e., in addition to the preforms/fibers extending into such cavity from the major segments), arranged as required for satisfying any additional mechanical requirements for the minor segments of the part.

A further aspect of the invention is forming a part having a complex geometry, which comprises placing a preform charge (having a complex geometry) in a mold, and then compression molding the preform charge to form the part. In this manner, a geometrically complex part with a desired fiber alignment (i.e., an alignment that achieves desired mechanical properties) is formed.

From a manufacturability perspective, it is desirable for the part being molded to exhibit bi-lateral symmetry. This typically simplifies the design of the fixture that creates the preform charge for the part. However, such symmetry is not required. A preform charge fixture can be readily designed to create a preform charge wherein the partitioning does not result in two identical halves.

Furthermore, in some embodiments, more than one partitioning axis is required to create the required preform charge due to the specifics of part geometry. For example, two such partitioning axes may be required. In some of the two-partitioning-axes scenarios, one of the portions resulting from the first partitioning is, in turn, partitioned, such that the two partitions divide the part into three portions for fabrication. In some other embodiments, the two partitions might involve wholly separate regions of the part, such that four portions result. As the number of partitions increases, some or all of the operations of the method described above are repeated, as necessary, to create the preform charge.

It is within the capabilities of those skilled in the art, in light of the present teaching, to determine (i) which geometrically-complex parts would benefit from being fabricated via the present methods, (ii) how many partitioning axes are required for forming the preform charge, (iii) the location of the partitioning axes, and (iv) how to design and build a fixture suitable for fabricating the preform charge that will be used to ultimately mold the part. In this regard, if the need for the present methods is not a priori obvious, then it will present itself as one skilled in the art attempts to fabricate a geometrically complex part using conventional techniques, but is hampered by the aforementioned issues (i.e., inability to lay-up the preforms due to gravity, challenges due the need for multiple compression axes, a need for fiber continuity between various portions of the part).

In some embodiments, the invention provides a method comprising:

determining at least one partitioning axis for a fiber-composite part, the partitioning axis defining at least a first portion and a second portion of a perform charge that is used to make the fiber-composite part, the first and second portions having:
(i) a major segment aligned with a first plane, and
(ii) a minor segment aligned with a second plane, wherein the two planes are not co-planar;
creating a fixture having segregable elements that form cavities that are shaped to define features included in the major segments and minor segments, and physically adapted to receive:
(i) a first layup of preforms for at least the major segment of the first portion of the preform charge,
(ii) a second layup of preforms for at least the major segment of the second portion of the preform charge, and
(iii) a third layup of preforms for the minor segments of the first portion and the second portion of the preform charge;

forming the first layup and partially consolidating same;

forming the second layup and partially consolidating same;

joining together at least some of the segregable elements of the fixture that are used to form the major segments of each portion of the preform charge, the two partially consolidated major segments residing therein;

forming the third layup, wherein cavity that receives the third layup has an out-of-plane orientation with respect to the partially consolidated major segments of the preform charge, the out-of-plane orientation being consistent with the non-coplanar relation between the major segments and the minor segments; and

partially-consolidating the minor segments of the preform charge to the major segments thereof, forming the preform charge.

In some embodiments, the invention provides a fixture comprising:

segregable elements that form a first cavity, a second cavity, and a third cavity, wherein:
(i) a first portion of the segregable elements combine to form the first cavity, wherein the first cavity is physically adapted to form a first portion of a major segment of a preform charge;
(ii) a second portion of the segregable elements combine to form the second cavity, wherein the second cavity is physically adapted to form a second portion of a major segment of the preform charge; and
(iii) the first portion and the second portion of segregable elements combine to form the third cavity, wherein the third cavity is physically adapted to form minor segments of the preform charge, wherein the first cavity and the second cavity align with a first plane, and the third cavity aligns with a second plane, wherein the first plane and the second plane are not co-planar.

In some embodiments, the invention provides a method comprising:

providing a fixture having segregable elements that form a first, second, and third cavity, wherein each cavity is shaped to define structural features associated with respective ones of a first, second, and third portion of a fiber-composite part;

forming a first portion of a preform charge, the first portion of the preform charge having a structure based on the first portion of the part, wherein the first portion of the preform charge is formed from the segregable elements that form the first cavity;

forming a second portion of the preform charge, the second portion of the preform charge having a structure based on the second portion of the part, wherein the second portion of the preform charge is formed from the segregable elements that form the second cavity;

joining together at least some of the segregable elements of the fixture that are used to form the first and second portions of the preform charge, the joined segregable elements forming a joint cavity that contains both the first and the second portions of the preform charge;

forming a third portion of the preform charge, the third portion of the preform charge having a structure based on the third portion of the part, wherein the third portion of the preform charge is formed from the segregable elements that form the third cavity, and wherein:
(a) the third cavity is fluidically coupled to the joint cavity; and
(b) during the forming of the third portion of the preform charge, the first portion, second portion, and third portion of the preform are joined together, thereby forming the preform charge.

### BRIEF DESCRIPTION OF THE DRAWINGS

FIG. 1A depicts a front view of a part/preform charge having a complex geometry.

FIG. 1B depicts a side view of the part/preform charge of FIG. 1A.

FIG. 1C depicts an isometric view of the part/preform charge of FIG. 1A.

FIG. 2 depicts a flow diagram of a method in accordance with the present teachings for making a fiber-composite part, such as a part having a complex geometry.

FIG. 3 depicts a flow diagram of a method in accordance with the present teachings for making a preform charge used in the method of FIG. 3.

FIGS. 4A and 4B depict an illustrative partitioning axis for the part of FIG. 1A, in accordance with the present teachings.

FIG. 5 depicts a fixture for making the preform charge of FIG. 1A.

FIG. 6A depicts a first portion of the fixture of FIG. 5, with a first spacer attached.

FIG. 6B depicts the first portion and spacer of FIG. 6A with a second spacer attached.

FIG. 7 depicts a plunger for use with the second portion of the fixture and the spacers, to partially consolidate a major portion of the preform charge.

FIG. 8A illustrates a path of a preform in the first portion of the fixture of FIG. 5.

FIG. 8B depicts a layup, in the first portion of the fixture of FIG. 5, for forming one of the major portions of the preform charge.

FIG. 9 depicts a plunger being used to partially consolidate a preform layup.

FIG. 10 depicts the fixture of FIG. 5, wherein the fixture contains two, mirror-image major portions of the preform charge, and the layup for forming the minor portions of the preform charge.

FIG. 11 depicts the fully formed preform charge in one half of the fixture.

### DETAILED DESCRIPTION

Definitions. The following terms are defined for use in this description and the appended claims:
“Tow” means a bundle of fibers (i.e., fiber bundle), and those terms are used interchangeably herein unless otherwise specified. Tows are typically available with fibers numbering in the thousands: a 1K tow, 4K tow, 8K tow, etc.
“Prepreg” means fibers that are impregnated with resin.
“Towpreg” means a fiber bundle (i.e., a tow) that is impregnated with resin.
“Preform” means a bundle of plural, unidirectionally aligned, same-length, resin-wetted fibers. The bundle is often (but not necessarily) sourced from a long length of towpreg. That is, the bundle is a segment of towpreg that has been cut to a desired size and, in many cases, is shaped (e.g., bent, twisted, etc.) to a specific form, as appropriate for the specific part being molded. The cross section of the preform, and the fiber bundle from which it is sourced typically has an aspect ratio (width-to-thickness) of between about 0.25 to about 6. Nearly all fibers in a given preform have the same length (i.e., the length of the preform) and, as previously noted, are unidirectionally aligned. Applicant's use of the term “preform” means a fiber-bundle-based preform, and explicitly excludes any size of shaped pieces of: (i) tape (typically having an aspect ratio—cross section, as above—of between about 10 to about 30), (ii) sheets of fiber, and (iii) laminates.
“Consolidation” means, in the molding/forming arts, that in a grouping of fibers/resin, void space is removed to the extent possible and as is acceptable for a final part. This usually requires significantly elevated pressure, either through the use of gas pressurization (or vacuum), or the mechanical application of force (e.g., platens, rollers, etc.), and elevated temperature (to soften/melt the resin).
“Fluidically coupled” means that liquid, gas, or vapor from a first region can flow to or otherwise cause an effect in a second region. For example, if two regions are fluidically coupled (or in fluidic communication), a pressure change in one of those regions might (but not necessarily will) result in a pressure change in the other of the regions.
“Partial consolidation” means, in the molding/forming arts, that in a grouping of fibers/resin, void space is not removed to the extent required for a final part. As an approximation, one to two orders of magnitude more pressure is required for full consolidation versus partial consolidation. As a further very rough generalization, to consolidate fiber composite material to about 80 percent of full consolidation requires only 20 percent of the pressure required to obtain full consolidation.
“Preform Charge” means an assemblage of preforms that are at least loosely bound together so as to maintain their position relative to one another. Preform charges can contain a minor amount of fiber in form factors other than fiber bundles, and can contain various inserts, passive or active. As compared to a final part, in which fibers/resin are fully consolidated, in a preform charge, the preforms are only partially consolidated (lacking sufficient pressure and possibly even sufficient temperature for full consolidation). By way of example, whereas applicant's compression-molding processes are often conducted at thousands of psi, the downward pressure applied to the preforms to create a preform charge in accordance with the present teachings is typically in the range of about 10 psi to about 100 psi, up to a maximum of about 500 psi. Thus, voids remain in a preform charge, and, as such, the preform charge cannot be used as a finished part.
“About” or “Substantially” means +/−20% with respect to a stated figure or nominal value.

A preform charge, as is used to form parts having a complex geometry, comprises a plurality of preforms. Preforms are typically formed from towpreg, but may also be sourced from the output of a resin impregnation line. Each preform include thousands of unidirectionally aligned, resin-infused fibers, typically in multiples of one thousand (e.g., 1k, 10k, 24k, etc.). A preform may have any suitable cross-sectional shape (e.g., circular, oval, trilobal, polygonal, etc.). The preforms are cut to a desired size, and, as appropriate, shaped.

The individual fibers in the towpreg/preforms can have any diameter, which is typically, but not necessarily, in a range of 1 to 100 microns. Individual fibers can include an exterior coating such as, without limitation, sizing, to facilitate processing, adhesion of binder, minimize self-adhesion of fibers, or impart certain characteristics (e.g., electrical conductivity, etc.).

Each individual fiber can be formed of a single material or multiple materials (such as from the materials listed below), or can itself be a composite. For example, an individual fiber can comprise a core (of a first material) that is coated with a second material, such as an electrically conductive material, an electrically insulating material, a thermally conductive material, or a thermally insulating material.

In terms of composition, each individual fiber can be, for example and without limitation, carbon, glass, natural fibers, aramid, boron, metal, ceramic, polymer filaments, and others. Non-limiting examples of metal fibers include steel, titanium, tungsten, aluminum, gold, silver, alloys of any of the foregoing, and shape-memory alloys. “Ceramic” refers to all inorganic and non-metallic, materials. Non-limiting examples of ceramic fiber include glass (e.g., S-glass, E-glass, AR-glass, etc.), quartz, metal oxide (e.g., alumina), aluminasilicate, calcium silicate, rock wool, boron nitride, silicon carbide, and combinations of any of the foregoing. Furthermore, carbon nanotubes can be used.

Any thermoplastic polymer resin that bonds to itself under heat and/or pressure can be used. Exemplary thermoplastic resins useful in conjunction with embodiments of the invention include, without limitation, acrylonitrile butadiene styrene (ABS), nylon, polyaryletherketones (PAEK), polybutylene terephthalate (PBT), polycarbonates (PC), and polycarbonate-ABS (PC-ABS), polyetheretherketone (PEEK), polyetherimide (PEI), polyether sulfones (PES), polyethylene (PE), polyethylene terephthalate (PET), polyphenylene sulfide (PPS), polyphenylsulfone (PPSU), polyphosphoric acid (PPA), polypropylene (PP), polysulfone (PSU), polyurethane (PU), polyvinyl chloride (PVC).

A single preform charge can comprise preforms that have fibers and/or resins that are different from one another. It is preferable to have the resin be the same through all preforms in a preform charge, but this is not necessary as long as the different resins are “compatible;” that is, as long as they bond to one another. A preform charge can also include inserts that are not fiber based.

The preform charge, which is typically a three-dimensional arrangement of preforms, is usually created in a fixture separate from the mold, and which is dedicated and specifically designed for that purpose. To create a preform charge, preforms are placed (either automatically or by hand) in a preform-charge fixture. By virtue of the configuration of the fixture, the preforms are organized into a specific geometry and then bound together, such as via heating and minimal applied pressure. The shape of the preform charge usually mirrors that of the intended part, or a portion of it, and, hence, the mold cavity (or at least a portion thereof) that forms the part. See, e.g., Publ. Pat. Apps. US2020/0114596 and US2020/0361122, incorporated herein by reference. The preform-charge fixtures disclosed herein, which include features that uniquely address the challenges required to fabricate certain geometrically complex parts as discussed herein, are unlike those described in the referenced publications.

As compared to a final part in which fibers/resin are fully consolidated, in a preform charge, the preforms are only partially consolidated. This is because there is insufficient pressure, and possibly even insufficient temperature for full consolidation. By way of example, whereas applicant's compression-molding processes are often conducted at a pressure of thousands of psi, the downward pressure applied to the constituents to create a preform charge in accordance with the present teachings is typically in the range of about 10 psi to a maximum of about 500 psi. Thus, voids remain in a preform charge, and, as such, the preform charge cannot be used as a finished part. Although a preform charge is not fully consolidated, the preforms in a preform charge will not move, thereby maintaining the desired geometry and the specific alignment of each preform in the assemblage. This is particularly important in the context of the present invention.

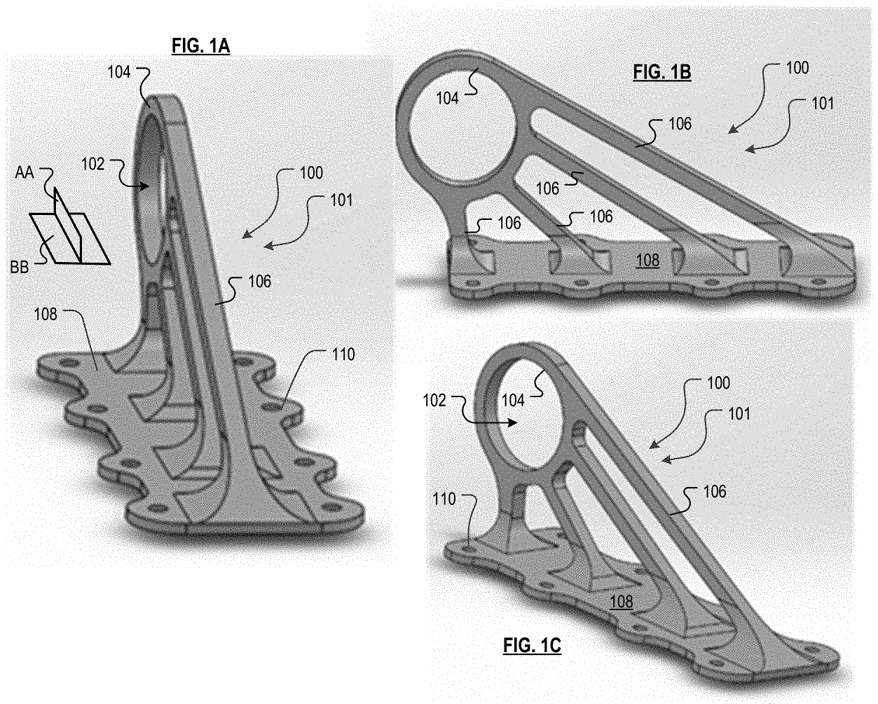

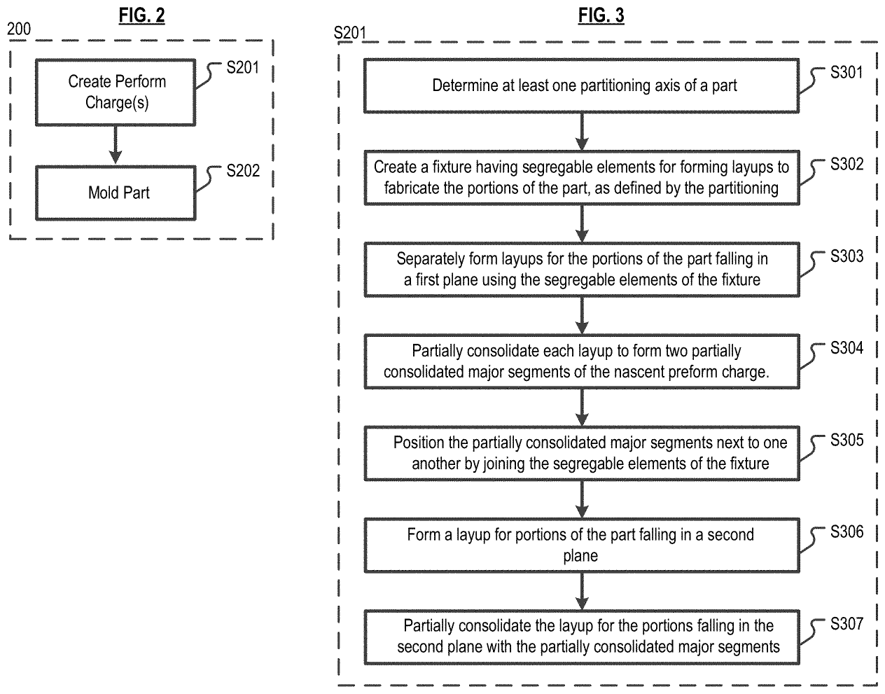

FIGS. 1A through 1C depicts bracket 100. The bracket includes receiver 102 defined by annular portion 104, a plurality of support beams 106, and base plate 108 having eight holes 110.

In a typically use case, base plate 108 attaches to a control surface (not depicted), such via screws/bolts (not depicted) that are received by holes 110. And receiver 102 receives a pin, etc., (not depicted), associated with the control surface. Bracket 100 attaches, via base plate 108, to a vertically oriented control surface. The aforementioned pin (passing through receiver 102) imparts a load that is directed upward, along a vector parallel to the vertically oriented control surface.

Bracket 100 exhibits a complex geometry: annular portion 104 and support beams 106 align with first plane AA, whereas base plate 108 aligns with second plane BB, wherein those two planes are not co-planar. In this particular embodiment, the first and second planes are, in fact, orthogonal to one another.

To optimally support the load for the use case described above, the following fiber alignment is used for bracket 100. Some of the fibers will wrap at least partially around one of the holes 110, cross a portion of base plate 108, traverse one of support beams, wrap partially around receiver 102 (in annular portion 104), traverse another of support beams 106, cross a portion of base plate 108, and wrap at least partially around another of holes 110. For such a fiber path, the fibers pass out-of-plane twice. Additionally, some fibers may wrap partially around only one of the holes, but otherwise extend through a support beam 106 and at least partially around receiver 102. In this manner, all eight of holes 110 will be at least partially wrapped by fibers that extending from support beams 106. This results in optimum load transfer from the applied load to the control surface, via fibers in tension. Additionally, there will be fibers within base plate 108 that do not wrap around holes 110, but are rather arranged to account for bending stresses in the base plate.

During a compression-molding process, the mold for bracket 100, once loaded with preforms, would likely orient base plate 110 (aligned with second plane BB) in a vertical orientation, with annular portion 104 and supports 106 (aligned with first plane AA) in a horizontal orientation. If the preforms that are placed in the mold are not at least minimally joined to one another, they will lose their positioning in the mold due to gravity. Maintaining this alignment from layup through finished product is only possible by unifying the preforms via a preform charge. Moreover, to achieve the requisite performance demanded by this use case, a near optimal fiber arrangement is necessary, wherein fibers extend between base plate 108 and support beams 106.

Thus, in a further aspect of the invention, a part is produced in accordance with method 200 depicted in FIG. 2. The method comprises the following operations:
S201: forming a preform charge; and
S202: molding the part.

An illustrative method for forming a preform charge (operation S201) is described below in conjunction with FIG. 3. To mold the part in accordance with operation S202, the preform charge is placed in the mold cavity of mold, the mold is closed, and heat and pressure are applied for a period of time. Note that typically, the preform charge is formed in a fixture that is different from the mold by which the preform charge is molded to a final part via compression molding.

For applicant's processes, the applied pressure during compression molding is usually in the range of about 500 psi to about 3000 psi, and temperature, which is a function of the particular resin being used, is typically in the range of about 150° C. to about 400° C. Once the applied heat has increased the temperature of the resin above its melt temperature, it is no longer solid and will flow. The resin will then conform to the mold geometry under the applied pressure. Elevated pressure and temperature are typically maintained for a few minutes. Thereafter, the mold is removed from the source of pressure and is cooled. Once cooled, the finished part is removed from the mold. In some embodiments in accordance with the present invention, loose preforms are placed in the mold in addition to the preform charge. In some embodiments, more than one preform charge having a complex geometry is placed in the mold to form the part.

In the illustrative embodiment, the preform charge has a shape that is quite similar to the final part (i.e., bracket 100). In other embodiments, this might not be the case. For convenience, the reference numerals used to identify the various features of bracket 100 will also be used to reference the analogous feature in the preform charge, wherein the preform charge is identified as “preform charge 101.” Stated somewhat differently, FIGS. 1A through 1C depict both bracket 100 and preform charge 101 for forming bracket 100. It is to be understood that as actually produced, a preform charge will have a rougher surface finish than a finished part. Also, because the preform charge is not fully consolidated, the molded part, which will be fully consolidated, will be “thinner” along the axes of compression. Consequently, the dimensions and aspect ratio of portions of the preform charge will be somewhat different than that of the finished part.

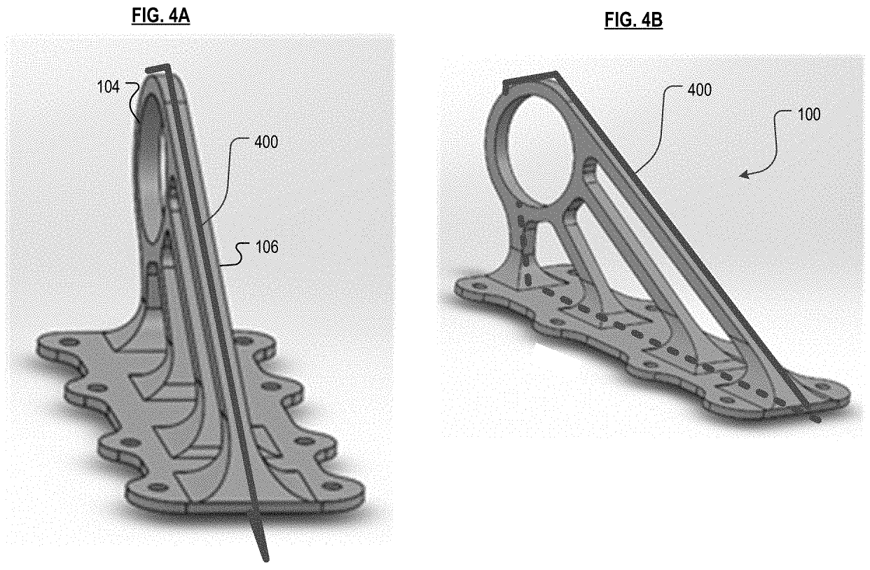

Referring now to FIG. 3, which depicts a method for forming a preform charge in accordance with the present teachings, operation S301 recites determining, for the part to be molded, at least one partitioning axis. By way of example, consider bracket 100 of FIGS. 1A through 1C. It is apparent that bracket 100 exhibits bilateral symmetry. Referring now to FIGS. 4A and 4B, an axis passing through receiver 102 and support beams 106 segregates bracket 100 into two mirror-image portions. That axis of bilateral symmetry, which is coincident with axis AA depicted in FIG. 1A, is designated as partition axis 400. Each of the portions resulting from partitioning includes a major segment and a minor segment. The major segment includes a “half-thickness” of annular portion 104, a half-thickness of support beams 106, and, a minor segment, which is one-half of the base plate 108 including four holes 110 and the surrounding structure.

The major segment of each portion is aligned with first plane AA (aligned with partition axis 400) and the minor segment of each portion aligns with a second plane, which in the illustrative embodiment is plane BB (see FIG. 1A).

To achieve the desired fiber alignment in the major segments (first plane) and in the minor segments (second plane), the preform charge fabrication sequence operates along two axes of compression, which in the case of this part, are orthogonal to one another. Thus, the preform charge cannot be fabricated by simply forming the two portions resulting from the partition; the base plate must be formed separately. Yet, to provide the requisite part strength, there must be continuity of at least some of the fibers between the first plane and the second plane. That is, some of the fibers that form support beams 106, and that make up annular portion 104, must extend into base plate 108 and ideally surround holes 110.

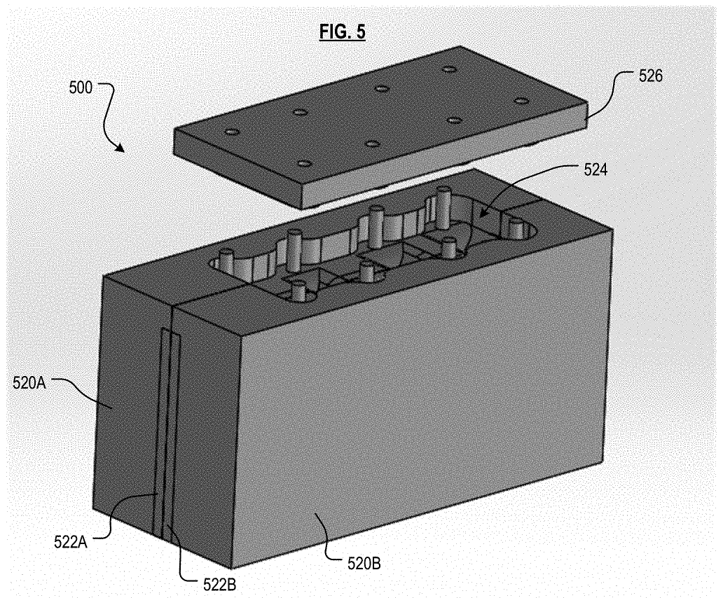

In operation S302, a fixture capable of forming the preform charge is created. The fixture includes segregable elements that, in this case, will be used to separately form the major segment of each portion of the preform charge. Furthermore, the fixture includes segregable elements for forming the minor segments of the preform charge and partially consolidating it with the major segments. Moreover, the fixture enables continuity of fiber between the major and minor segments. Before continuing with the discussion of the method of FIG. 3, a fixture capable of forming preform charge 101 is described in conjunction with FIGS. 5, 6A, 6B and 7.

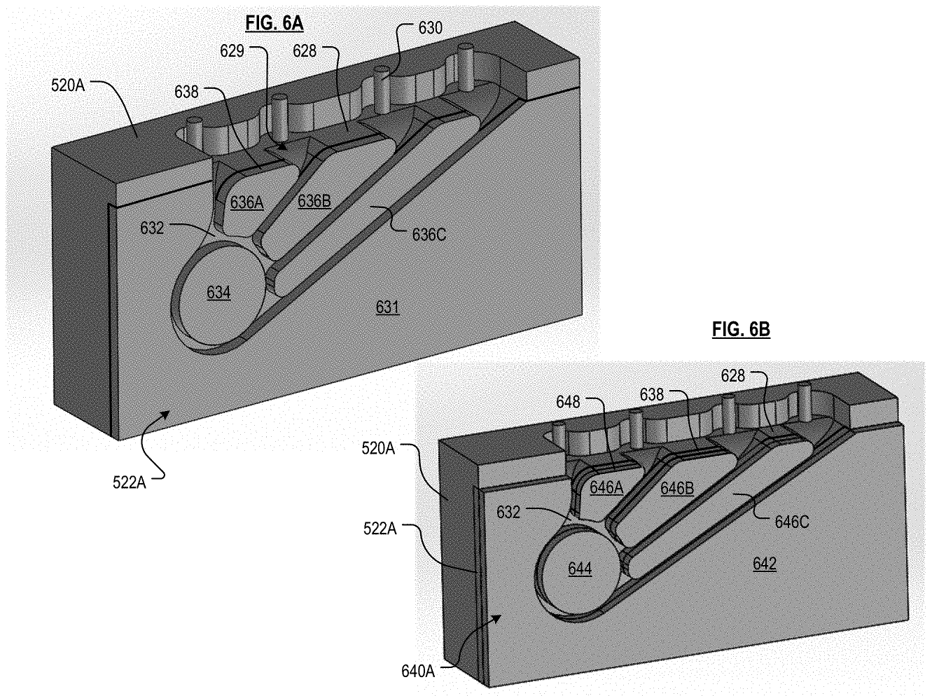

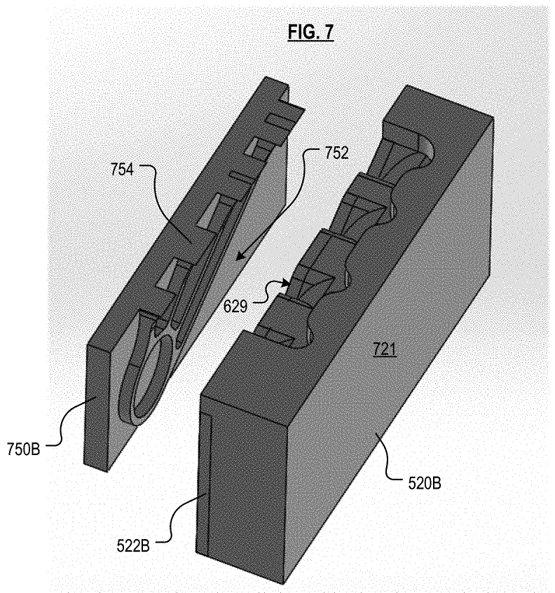

FIG. 5 depicts fixture 500, which is an embodiment of a fixture suitable for forming preform charge 101 for molding bracket 100. Fixture 500 includes fixture parts 520A, 520B, and spacers 522A and 522B, as well as other parts shown in FIGS. 6B and 7. Fixture part 520A and spacer 522A (as well as an additional spacer depicted in FIG. 6B) are used to form the major segment of one of the two portions of the preform charge. Each major segment is a half-thickness of annular portion 104 and a half-thickness of support beams 106. Similarly, fixture part 520B and spacer 522B (as well as an additional spacer) are used to form the major segment of the other portion of preform charge 101.

Furthermore, when coupled as depicted in FIG. 5, fixture parts 520A and 520B, and spacers 522A and 522B are used in conjunction with part 526 to form the minor segment(s) (base plate 108) of the preform charge. In this regard, as depicted in FIG. 5, when the aforementioned fixture parts are coupled to one another, cavity 524 is formed. This cavity receives a plurality of preforms that ultimately forms base plate 108. The preforms are not arbitrarily placed; some will be positioned to transfer stress between the holes that will be formed in the base plate. It is notable that fixture parts 520A and 520B are mirror images of one another, and thus are not identical to one another.

FIG. 6A depicts fixture part 520A and spacer 522A. In the embodiment shown, spacer 522A defines those features of preform charge 101 falling substantially in plane AA; in other words, annular portion 104 and support beams 106. To do so, spacer 522A includes planar region 631, circular region 634, and freeform regions 636A, 636B, and 636C. The gaps or channels formed between these regions define cavity 632. The cavity defines the shape of annular portion 104 and support beams 106. Although implemented in this embodiment as a piece that is removable from fixture part 520A, the various elements making up spacer 522A could be integral to fixture part 520A in some other embodiments. The removable nature of spacer 522A facilitates the eventual removal of the preform charge from the fixture.

Surface 628, as defined in a recessed region in the “uppermost” portion (in FIG. 6A) of fixture part 520A, and surface 638 defined by upper edge of freeform regions 636A, 636B, and 636C, form one-half of cavity 524 (FIG. 5). As previously mentioned, cavity 524 is used to form base plate 108 of the preform charge. Pins 630 extending upwardly from surface 628 are used to form holes 110 in base plate 108.

Surface 628 defining the bottom of the cavity 524 is not continuous; there are a plurality of openings 629 that connect cavity 632 (for forming annular portion 104 and support beams 106) to cavity 524 (for forming base plate 108). Openings 629 provide the requisite connectivity between the cavities so that preforms can extend out-of-plane (i.e., partially in the plane of cavity 632 and partially in the plane of cavity 524) to create the desired fiber alignment, which typically requires at least some continuity of fiber between these cavities.

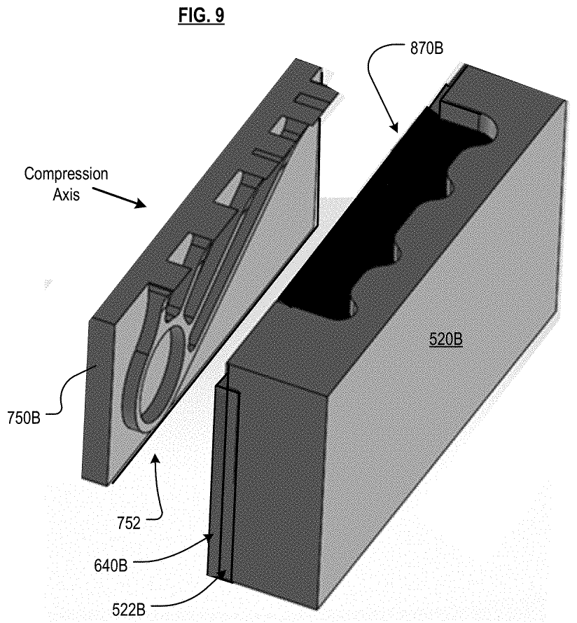

FIG. 6B depicts fixture part 520A with additional spacer 640A coupled to the outward facing surface of spacer 522A. Spacer 640B (see, FIG. 9) is used in conjunction with fixture part 520B and spacer 522B to the same effect. Additional spacer 640A/640B provides extra depth to cavity 632. This is required since, to create the preform charge, the preforms are partially consolidated (using heat and pressure). Those skilled in the art will recognize that unconsolidated preforms take up significantly more space (in the direction of the applied force) than partially consolidated preforms. In this embodiment, spacer 640A/640B doubles the depth of cavity 632. Thus, if cavity 632 depicted in FIG. 6A were full of preforms, it would have about half the amount of preforms required. Stacking spacer plate 640A onto spacer 522A deepens cavity 632 to accommodate the other half of the necessary preforms.

It is notable that spacer “plate” 640A is not a single plate; rather, it is composed of five separate parts: plate portion 642, circular region 644, freeform regions 646A, 646B, and 646C. Each of these parts are abutted and affixed to like features of spacer 522A. In some other embodiments, rather than using a second spacer plate (i.e., plate 640A), spacer 522A could be made “deeper” (i.e., a double thickness) and further recessed into body of fixture part 520A. However, as for the use of spacer 522A, the use of the additional discrete spacer facilitates the eventual removal of the preform charge from the fixture.

FIG. 7 depicts male portion or plunger 750B, which is used in conjunction with female fixture part 520B to consolidate preforms that have been placed therein. Male portion or plunger 750A (not depicted), which is a mirror image of plunger 750B, is used in conjunction with fixture part 520A. The following description applies to both plungers, each for effecting partial consolidation of a respective one of the two major segments of the two portions of the nascent preform charge.

As depicted in FIG. 7, plunger 750B includes “raised” feature 752, which has the form of annular portion 104 and support beams 106, and is dimensioned to fit within the various channels and openings defining cavity 632. When engaged to fixture 520B (and two spacers 522B, 640B, only one of which is shown), and when cavity 632 is full of preforms, plunger 750B partially consolidates the preforms under applied temperature and pressure. Tabs 754 of plunger 750B are positioned to interdigitate with openings 629 of fixture part 520B. The tabs partially consolidate any preforms that extend from cavity 632 into the recessed region (forming part of cavity 524) and that wrap around hole-forming pins 630 (see FIGS. 6A/6B, etc.). It is notable that during partial consolidation, fixture part 520B does not necessarily have orientation depicted in FIG. 7, particularly if, in this Figure, the reference frame of gravity is acting “downward” (i.e., from the upper surface of fixture 520 to its lower surface). Rather, in some embodiments, and assuming the aforementioned reference direction for gravity, fixture part 520B rests on surface 721 during the partial consolidation operation.

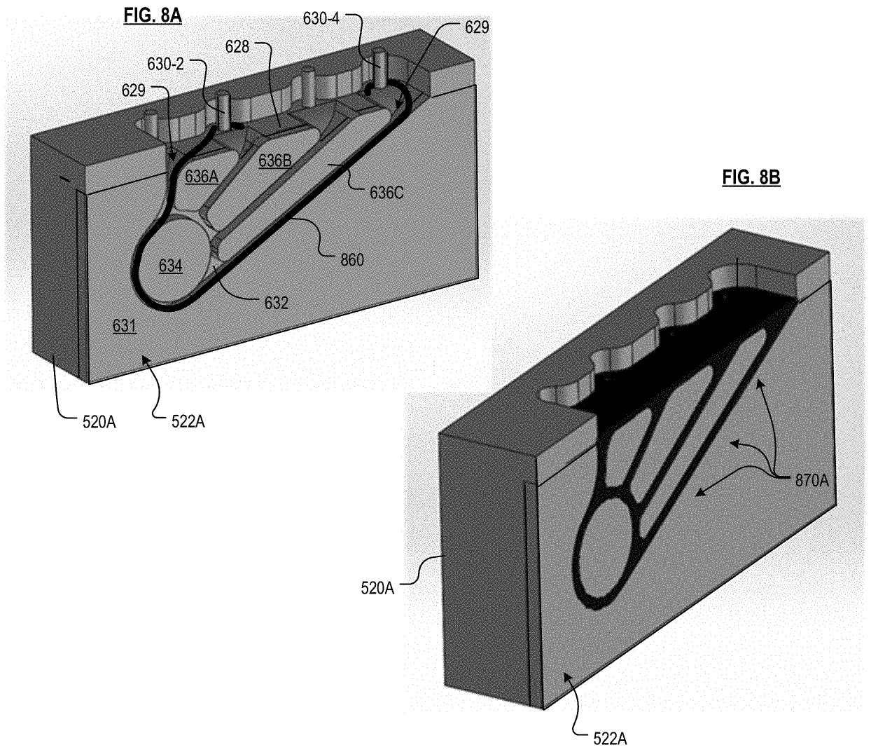

Returning now to the discussion of the method of FIG. 3, the various operations of the method will be referenced to fixture 500, as illustrated in FIGS. 8A/B and 9-11. Once again, to best address the anticipated load experienced by bracket 100 when it is in use, some of the fibers comprising the fiber-composite bracket should wrap at least part way around receiver 102 in annular portion 104, pass along beams 106, and extend to and around holes 110 in base 108 (FIGS. 1A-1C). Embodiments of the invention, such as the method depicted in FIG. 3, in conjunction with fixture 500, enable this fiber alignment.

It bears repeating that fixture 500 is used to form a preform charge, not a final molded part, even though in this embodiment, the preform charge has a shape that is essentially identical to that of the bracket (i.e., bracket 100).

In operation S303, separate preform layups are formed for the portions of the part falling in a first plane (the major segments), using the segregable elements of the fixture. With reference to FIGS. 4A and 4B, for bracket 100, there are two such major segments; that is, there are two mirror-image, half-thickness portions of annular portion 104 and support beams 106. In the context of fixture 500, this involves forming a first preform layup in fixture part 520A and a second preform layup in fixture part 520B. The two spacers (e.g., 522A and 640A for fixture part 520A, and 522B and 640B for fixture part 520B) are attached to each of the two fixture parts to provide sufficient cavity depth to accommodate the requisite amount of preforms.

FIG. 8A depicts the fixture parts for forming one of the portions of the bracket falling in the first plane: fixture part 520A and spacer 552A (spacer 640A omitted for clarity). This figure shows fiber-bundle-based preform 860, which, along with other preforms (not depicted) following the same path, will form the shortest and longest support beams 106 and a portion of the annular portion 104 of preform charge 101. In particular, preform 860 wraps partially around pin 630-2, crosses surface 628, enters opening 629 to pass into cavity 632 and through a channel formed between plate 631 and freeform region 636A, passes through a channel formed between plate 631 and circular region 634, passes through a channel formed between plate 631 and freeform region 636C, extends out of plane crossing surface 628 and partially wraps around pin 630-4. Other preforms will follow similar paths to engage other pins, etc. It is notable that fixture part 520A would typically be lying flat on its side to receive preforms. This ensures that the preforms remain in the cavity, rather than possibly falling out under the influence of gravity, as is likely if fixture part 520A is oriented as depicted in FIG. 8A.

FIG. 8B depicts preform layup 870A in fixture part 520A/spacer 522A (spacer 640A omitted for clarity), per operation S303. A similar layup is created in fixture 520B (see FIG. 9). Pins 630 are omitted for clarity. In FIG. 8B, the preforms are depicted as an undifferentiated mass; it is to be understood that at this point in the method (prior to partial consolidation), each preform is a distinct bundle of resin-infused fibers. Moreover, it will be appreciated that at least some of the various preforms in the layup will have different shapes and lengths from others of the preforms in the layup. It is notable that since second spacer 640A is not depicted in FIG. 8B, only one-half the preforms that are required for forming this particular “half-thickness” of annular portion 104 and support beams 106 are present. (See, e.g., FIG. 9, wherein both spacers that accompany fixture part 520B are present, such that the cavity formed thereby is deep enough to accommodate all required preforms.)

Operation 303 is directed to forming layups that fall in first plane AA (i.e., annular portion 104 and support beams 106). But as depicted in FIG. 8B, some preforms are present in what is effectively half of cavity 524, which is the cavity that receives the layup that forms the portion of the part that falls in second plane BB (i.e., base plate 108). As previously discussed, it is important that fibers extend between base plate 108 and support beams 106, etc., for best mechanical properties of bracket 100. For this to occur, some preforms must extend from cavity 632 (for forming annular portion 104 and support beams 106) into the region that forms cavity 524 before partial consolidation of the layups in operation 303. Otherwise, there would be no continuity of fiber between base plate 108 and support beams 106. The fixture used to form the preform charge, must provide such connectivity between cavities.

FIG. 9 depicts plunger 750B, and preform layup 870B in fixture part 520B and spacers 522B and 640B. Pins 630, which, this point in the method, would be extending upwardly from the upper cavity of fixture part 520B, are omitted for clarity. In preparation for operation S304 (partially consolidating the preform layups), plunger 750B is coupled to the layup-containing-assemblage of fixture part 520B and spacers 522B and 640B. Although not depicted, plunger 750A is similarly coupled to the layup-containing-assemblage of fixture part 520A and spacers 522A and 640A.

In accordance with operation S304, the preforms in layups are then partially consolidated. As the plunger, for example plunger 750B, travels along its compression axis, preform layup 870B is partially consolidated under heat and pressure into the major segment of one of the portions of preform charge 101.

This partial consolidation step reduces the “height” or thickness of preform layup 870B in cavity 632 (FIGS. 6A/6B), such that it becomes flush with the outward-facing surface of spacer 522B. The second spacer—spacer 640B—is removed following the partial consolidation. This process is performed separately for the two preform layups (i.e., 870A in fixture part 520A, and 870B in fixture part 520B). Each of the resulting partially consolidated major segments of the nascent preform charge remains in its respective fixture part/spacer.

The preforms within respective fixture parts 520A and 520B, which include thermoplastic polymer resin, are softened, via the application of heat, energy, etc. The temperature (the “heat deflection temperature”) at which the preforms will soften is a function of the particular thermoplastic used, and the applied pressure. (The heat deflection temperature is not a property of a thermoplastic; rather, it is a measure of a polymer's resistance to distortion under a given load at elevated temperature.) It is within the capabilities of those skilled in the art to determine the temperature at which any given thermoplastic resin will soften. For example, for PA6 (nylon 6), the heat deflection temperature is about 320° F. at the relevant pressure, and this is the temperature at which a PA6-based preform will soften. If the preforms are to be simply “surface tacked,” as opposed to partially consolidated, gravity alone provides sufficient compressive force. However, to partially consolidate the preforms to any extent, gravity alone is insufficient. Rather, for partial consolidation, an externally applied compressive force is required, such as squeezing plunger 750B against spacer plate 640B. The applied pressure is typically between 10 to 100 psi, but may be as high as 500 psi for certain thermoplastics, such as PEEK.

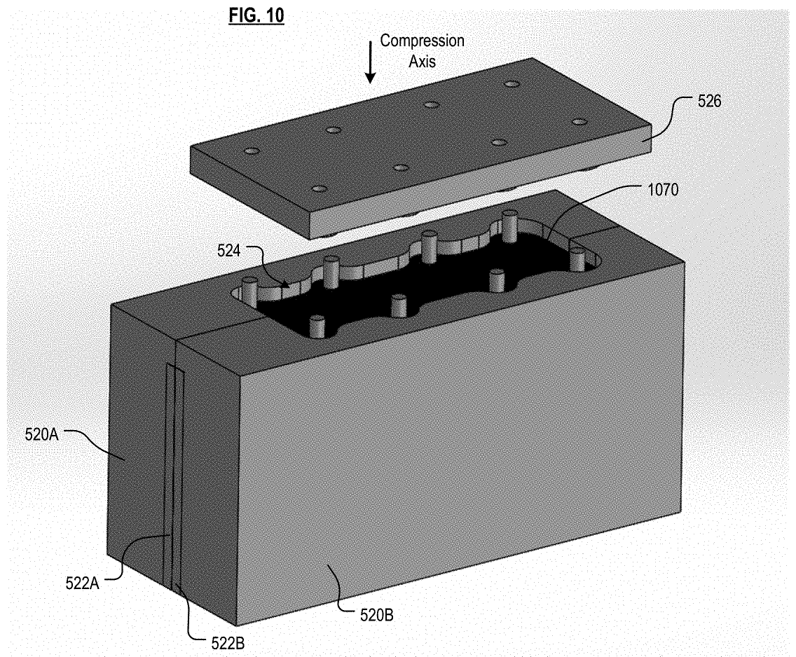

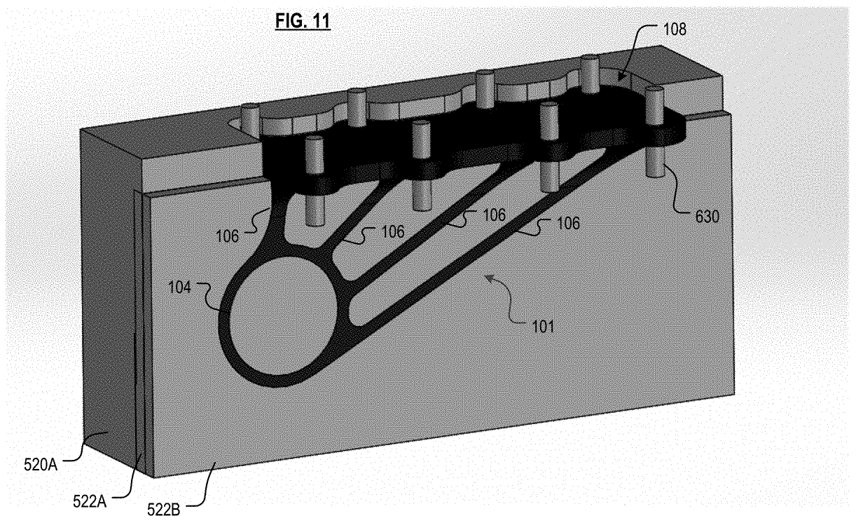

Referring now to FIG. 10, and in accordance with operation S305, fixture parts 520A and 520B (with respective spacers 522A and 522B) are attached to one another, thereby placing the two, mirror-image, partially consolidated major segments next to one another. Note that since the layups formed in operation S303 have been partially consolidate in operation S304, the secondary spacers 640A and 640B are not present.

With these parts and spacers attached to one another, cavity 524 is formed “above” the now-abutting partially consolidated major segments of the nascent preform charge. Fibers extending from the partially consolidate major segments are wrapped around pins. The pins will form holes 110 in base plate 108. And, as previously discussed, the fibers extending from the partially-consolidate major segments provide continuity of fiber.

Per operation S306, additional preforms are placed in cavity 524, supplementing as required the portions of the preforms extending from the partially consolidated major segments. This forms layup 1070, which includes all the preforms required for forming base plate 108. At least some of the preforms in layup 1070 do not wrap around holes 110, but, rather, are arranged to account for bending stresses in the base plate.

After layup 1070 is formed, and in accordance with operation S307 of the method of FIG. 3, male fixture part 526 is attached to the parts 520A and 520B to apply force along a compression axis, effecting a final partial-consolidation operation. This operation unites all the portions of the nascent preform charge, thus creating preform charge 101. It is notable that although there is no compression applied that forces the two partially consolidated major segments together during this step, beyond that of attaching fixture parts 520A and 520B (with the major segments therein), they will nevertheless attach to one another as the resin therein softens.

FIG. 11 depicts the finished preform charge 101, still remaining in fixture part 520A and spacers 522A and 522B. After the partial consolidation is complete, the fixture is disassembled: male fixture part 526 is removed (already done in FIG. 11), pins 630 are removed (pins are shown in FIG. 11 for reference), and one of the fixture parts, such as fixture part 520B is removed (already done in FIG. 11). Spacer 522B would be removed next, and, optionally, spacer 522A is then removed. The preform charge is then removed from part 520A.

It is to be understood that the disclosure describes a few embodiments and that many variations of the invention can easily be devised by those skilled in the art after reading this disclosure and that the scope of the present invention is to be determined by the following claims.

What is claimed:

1. A method comprising:
determining at least one partitioning axis for a fiber-composite part, the partitioning axis defining at least a first portion and a second portion of a perform charge that is used to make the fiber-composite part, the first and second portions having:
(i) a major segment aligned with a first plane, and
(ii) a minor segment aligned with a second plane, wherein the two planes are not co-planar,
creating a fixture having segregable elements that form cavities that are shaped to define features included in the major segments and minor segments, and the cavities physically adapted to receive:
(i) a first layup of preforms for at least the major segment of the first portion of the preform charge;
(ii) a second layup of preforms for at least the major segment of the second portion of the preform charge; and
(iii) a third layup of preforms for the minor segments of the first portion and the second portion of the preform charge;
forming the first layup and partially consolidating same;
forming the second layup and partially consolidating same;
joining together at least some of the segregable elements of the fixture that are used to form the major segments of each portion of the preform charge, the two partially consolidated major segments residing therein;
forming the third layup, wherein cavity that receives the third layup has an out-of-plane orientation with respect to the partially consolidated major segments of the preform charge, the out-of-plane orientation being consistent with the non-coplanar relation between the major segments and the minor segments; and
partially consolidating the minor segments of the preform charge to the major segments thereof, forming the preform charge.

2. The method of claim 1 wherein the two planes are orthogonal to one another.

3. The method of claim 1 and further comprising:
placing the preform charge in a mold; and
compression molding the preform charge to form the fiber-composite part.

4. The method of claim 1 wherein the fiber-composite part exhibits bilateral symmetry, and has plane defining an axis of bilateral symmetry, wherein the partitioning axis aligns with the axis of bilateral symmetry.

5. The method of claim 1 wherein the fiber-composite part comprises a bracket, the bracket comprising a base plate, wherein the base plate is the minor segment of the fiber-composite part, and wherein the base plate is physically adapted for attachment to a surface.

6. The method of claim 5 wherein the bracket comprises a receiver portion and support beams, wherein the receiver portion and the support beams are the major segment of the fiber composite part.

7. The method of claim 1 wherein forming the first layup comprises positioning at least a portion of some of the preforms of the first layup in the cavity that receives the third layup of preforms.

8. The method of claim 7 wherein forming the second layup comprises positioning at least a portion of some of the preforms of the second layup in the cavity that receives the third layup of preforms.

9. A fixture comprising:
segregable elements that form a first cavity, a second cavity, and a third cavity, wherein:
(i) a first portion of the segregable elements combine to form the first cavity, wherein the first cavity is physically adapted to form a first portion of a major segment of a preform charge;
(ii) a second portion of the segregable elements combine to form the second cavity, wherein the second cavity is physically adapted to form a second portion of a major segment of the preform charge;
(iii) the first portion and the second portion of segregable elements combine to form the third cavity, wherein the third cavity is physically adapted to form minor segments of the preform charge, wherein the first cavity and the second cavity align with a first plane, and the third cavity aligns with a second plane, wherein the first plane and the second plane are not co-planar.

10. The fixture of claim 9 wherein the first plane and the second plane are orthogonal to one another.

11. The fixture of claim 9 wherein fixture exhibits bilateral symmetry, wherein the first portion of segregable elements and the first cavity are mirror images of the second portion of segregable elements and the second cavity, respectively.

12. The fixture of claim 7 wherein the first portion of segregable elements includes a part of the third cavity.

13. The fixture of claim 12 wherein the first cavity is fluidically coupled to the part of the third cavity.

14. A method comprising:
providing a fixture having segregable elements that form a first, second, and third cavity, wherein each cavity is shaped to define structural features associated with respective ones of a first, second, and third portion of a fiber-composite part;
forming a first portion of a preform charge, the first portion of the preform charge having a structure based on the first portion of the part, wherein the first portion of the preform charge is formed from the segregable elements that form the first cavity;
forming a second portion of the preform charge, the second portion of the preform charge having a structure based on the second portion of the part, wherein the second portion of the preform charge is formed from the segregable elements that form the second cavity;
joining together at least some of the segregable elements of the fixture that are used to form the first and second portions of the preform charge, the joined segregable elements forming a joint cavity that contains both the first and the second portions of the preform charge;
forming a third portion of the preform charge, the third portion of the preform charge having a structure based on the third portion of the part, wherein the third portion of the preform charge is formed from the segregable elements that form the third cavity, and wherein:
(a) the third cavity is fluidically coupled to the joint cavity; and
(b) during the forming of the third portion of the preform charge, the first portion, second portion, and third portion of the preform are joined together, thereby forming the preform charge.

15. The method of claim 14 wherein forming the first portion of a preform charge comprises forming a first lay-up in the first cavity, the first layup comprising a plurality of fiber-bundle-based preforms.

16. The method of claim 15 wherein forming the first portion of the preform charge comprises positioning, in region that forms part of the third cavity, as defined by the segregable elements that form the first cavity, a portion of each of some of the fiber-bundle-based preforms from the first lay-up.

17. The method of claim 16 wherein forming the third portion of the preform charge comprises forming a third layup, wherein the third layup comprises said portions of fiber-based preforms from the first lay-up, and additional preforms that are placed in the third cavity.
